(19) United States
(12) Patent Application Publication
(10) Pub. No.: US 2005/0134703 A1
(43) Pub. Date: Jun. 23, 2005

(54) Method, electronic device, system and computer program product for naming a file comprising digital information

(75) Inventor: Nitin Mittal, Westcove (SG)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/742,745

(22) Filed: Dec. 19, 2003

(51) Int. Cl. H04N 5/76; G03B 17/24

(52) U.S. Cl. 348/231.2; 348/231.4; 396/312

(57) ABSTRACT

A method, electronic devices, system and computer program products of naming a file comprising digital information using an electronic device connected to a camera. In the method, digital information is recorded with the camera into a file. The file is named according to verbal information. Particularly, in the invention a digital picture or digital video file is named according to the verbal information given by a user at close proximity to the recording moment.

### BACKGROUND OF THE INVENTION

1. Field of the Invention

The present invention relates to terminal devices. In particular, the present invention relates to a novel and improved method, electronic device, system and computer program product for naming a file comprising digital information.

2. Description of the Related Art

The use of digital cameras has considerably increased as digital camera prices have dropped. A digital camera usually contains a removable memory card to which a plurality of digital pictures or video clips are saved. Each picture or video clip is typically saved as a separate file having a unique file name. One possible file naming technique is to use running file numbers so that successive pictures have successive file numbers (e.g. 100_{—}0001.jpg, 100_{—}0002.jpg, 100_{—}0003.jpg etc.). Another technique is to have a static selectable common part at first and have a running sequence after the static part (e.g. home0001.jpg, home0002.jpg, home0003.jpg etc.). Some digital cameras enable also a feature with which recorded sound can be attached to a digital picture.

The aforementioned naming techniques can also be used in mobile terminals, in e.g. mobile phones comprising a digital camera. Each digital picture or video clip is given a unique file name after the picture or video clip has been taken.

It is apparent that the aforementioned file naming techniques do not provide a user-friendly way for naming file names. A memory capacity of a mobile terminal or a memory capacity of memory cards for digital cameras typically enables hundreds of pictures to be stored on the memory or memory card. Therefore, it is not usually possible, based merely on the file names without viewing the files, to distinguish pictures or video clips from each other afterwards.

It is always possible e.g. to download digital pictures or video clips from a digital camera to a computer. Using the computer the digital picture files or video clips can be renamed to have more illustrative file names. This is, however, complicated since there might be hundreds of pictures and video clips to be renamed. Furthermore, one may have problems in renaming files if one does not e.g. accurately remember the place where the picture or video clip was taken or persons in the picture or video clip.

Therefore, there is an obvious need for a solution that would enable instant illustrative naming of digital pictures or video clips taken. A further need is to provide a solution that can be used to rename digital pictures or video clips after they have been taken.

### SUMMARY OF THE INVENTION

The invention relates to naming of a picture or a video clip after the picture or clip has been taken. Particularly, in the invention the picture or video clip is named according to verbal information, e.g. a spoken word or sentence at close proximity to the recording moment of the picture or video clip.

According to one aspect of the invention there is provided a method of naming a file comprising digital information using an electronic device comprising or connected to a camera. The method comprises the steps of recording digital information with a camera into a file; and naming the file according to verbal information given by a user at close proximity to the recording moment.

In one embodiment of the invention, the method further comprises the steps of storing the recorded digital information; recording verbal information with a microphone; storing the verbal information; converting the recorded verbal information into a form of a textual file name for a file comprising the recorded digital information; and saving the file using the textual file name.

In one embodiment of the invention, the spoken file name is recorded with the electronic device and associated with the recorded digital information. Also the actual speech to text conversion is performed with the electronic device. Therefore, in this embodiment the method further comprises the steps of storing the recorded digital information; recording verbal information with a microphone in connection with the electronic device; storing the verbal information; and associating the recorded verbal information with the recorded digital information. The recorded verbal information is then converted into a form of a textual file name for a file comprising the recorded digital information using the electronic device, and the file is saved using the textual file name. The speech to text conversion may be performed right after the digital information has been recorded or alternatively on a desired moment earlier or later on.

In one embodiment of the invention, the spoken file name is recorded with the electronic device and associated with the recorded digital information. The actual speech to text conversion, however, is performed elsewhere. Therefore, the method further comprises the steps of transferring the recorded digital information and the associated recorded verbal information to an external electronic device; storing the recorded digital information; storing the recorded verbal information; converting the recorded verbal information into a form of a textual file name for a file comprising the recorded digital information using the external electronic device; and saving the file using the textual file name.

In one embodiment of the invention, the electronic device itself does not store any piece of recorded information but only transmits the digital information and the verbal information to an external electronic device, e.g. a computer. Therefore, the method further comprises the steps of recording verbal information with a microphone in connection with the electronic device; transferring the recorded digital information and the recorded verbal information to an external electronic device; storing the digital information; storing the verbal information; converting the recorded verbal information into a form of a textual file name for a file comprising the recorded digital information using the external electronic device; and saving the file using the textual file name.

In one embodiment of the invention, the electronic device itself does not store any piece of recorded information but only transmits the taken digital information to an external electronic device, e.g. a computer. Therefore, the method further comprises the steps of transferring the recorded digital information to an external electronic device; storing the digital information; recording verbal information with a microphone in connection with the external electronic device; storing the verbal information; converting the recorded verbal information into a form of a textual file name for a file comprising the recorded digital information using the external electronic device; and saving the file using the textual file name.

In one embodiment of the invention, the step of recording comprises recording the verbal information before recording the digital information. In another embodiment, the step of recording comprises recording the verbal information after recording the digital information.

In one embodiment of the invention, the method further comprises the step of determining a time period during which it is possible to verbally name said digital information.

In one embodiment of the invention, the electronic device is one of a mobile terminal, a web camera, digital camera, digital video camera and a computer.

According to another aspect of the invention there is provided an electronic device comprising a camera or connection to a camera configured to record digital information; a first memory configured to store the digital information; a microphone configured to record verbal information; a second memory configured to store the verbal information; a converter configured to convert the verbal information into a form of a textual file name for a file comprising the recorded digital information; wherein the first memory is configured to store the file using the textual file name.

According to another aspect of the invention there is provided an electronic device comprising a camera or a connection to a camera configured to record digital information; a first memory configured to store the digital information; a microphone configured to record verbal information; a second memory configured to store the verbal information, wherein the first memory and second memory are associated so that the recorded verbal information is linked with the recorded digital information; and a transmitter configured to transmit the recorded digital information and the associated recorded verbal information to an external electronic device.

In one embodiment of the invention, the electronic device is one of a mobile terminal, a web camera, digital camera, digital video camera and a computer.

In one embodiment of the invention, at least one of the first memory and second memory is an internal memory of the electronic device.

In one embodiment of the invention, at least one of the first memory and second memory is a memory medium removably insertable into the electronic device.

In one embodiment of the invention, the first memory and second memory refer to a single memory area. In another embodiment of the invention, the first memory and second memory refer to separate memory areas.

In one embodiment of the invention, the electronic device further comprise a timer configured to determine a time period during which it is possible to verbally name the digital information.

According to another aspect of the invention there is provided an external electronic device comprising a receiver configured to receive recorded digital information and associated recorded verbal information from an electronic device; a first memory configured to store the digital information; a second memory configured to store the verbal information; a converter configured to convert the verbal information into a form of a textual file name for a file comprising the recorded digital information; and wherein the first memory is configured to store the file comprising the recorded digital information using the textual file name.

According to another aspect of the invention there is provided an external electronic device comprising: a receiver configured to receive recorded digital information a from an electronic device; a first memory configured to store the digital information; a microphone configured to record verbal information; a second memory configured to store the verbal information; a converter configured to convert the verbal information into a form of a textual file for a file comprising the recorded digital information; and wherein the first memory is configured to store the file comprising the recorded digital information using the textual file name.

In one embodiment of the invention, the electronic device is one of a mobile terminal and a computer.

In one embodiment of the invention, at least one of the first memory and second memory is an internal memory of the external electronic device.

In one embodiment of the invention, at least one of the first memory and second memory is a memory medium removably insertable into the external electronic device.

In one embodiment of the invention, the first memory and second memory refer to a single memory area. In another embodiment of the invention, the first memory and second memory refer to separate memory areas.

In one embodiment of the invention, the external electronic device further comprises a timer configured to determine a time period during which it is possible to verbally name the digital information.

According to another aspect of the invention there is provided a system of naming a file comprising digital information. The system comprises an electronic device comprising a camera or connected to a camera configured to record digital information; a first memory configured to store the recorded digital information; a microphone configured to record verbal information; a second memory configured to store the verbal information; a converter configured to convert the verbal information into a form of a textual file name for a file comprising the recorded digital information; wherein the first memory is configured to store the file comprising the recorded digital information using the textual file name.

According to another aspect of the invention there is provided a system of naming a file comprising digital information. The system comprises a first electronic device; wherein the first electronic device comprises a camera or is connected to a camera configured to record digital information; a first memory configured to store the recorded digital information; a microphone in connection with the first electronic device configured to record verbal information; a second memory configured to store the verbal information, wherein the first memory and second memory are associated so that the recorded verbal information is linked with the recorded digital information; and a transmitter configured to transmit the recorded digital information and the associated recorded verbal information to a second electronic device external to the first electronic device; and a second electronic device, wherein the second electronic device comprises a receiver configured to receive the recorded digital information and associated recorded verbal information from the first electronic device; a first memory configured to store the recorded digital information; a second memory configured to store the verbal information; a converter configured to convert the verbal information into a form of a textual file name for a file comprising the recorded digital information; and wherein the first memory is configured to store the file using the textual file name.

According to another aspect of the invention there is provided a system of naming a file comprising digital information. The system comprises a first electronic device, wherein the first electronic device comprises a camera or is connected to a camera configured to record digital information; a microphone in connection with the first electronic device configured to record verbal information; and a transmitter configured to transmit the recorded digital information and the recorded verbal information to a second electronic device external to the first electronic device; and a second electronic device, wherein the second electronic device comprises a receiver configured to receive the recorded digital information and the recorded verbal information from the first electronic device; a first memory configured to store the recorded digital information; a second memory configured to store the verbal information; a converter configured to convert the verbal information into a form of a textual file name for a file comprising the recorded digital information; and wherein the first memory is configured to store the file using the textual file name.

According to another aspect of the invention there is provided a system of naming a file comprising digital information. The system comprises a first electronic device, wherein the first electronic device comprises a camera or is connected to a camera configured to record digital information; and a transmitter configured to transmit the recorded digital information to a second electronic device external to the first electronic device; and a second electronic device, wherein the second electronic device comprises a receiver configured to receive the recorded digital information from the first electronic device; a first memory configured to store the recorded digital information; a microphone in connection with the second electronic device configured to record verbal information; a second memory configured to store the verbal information; a converter configured to convert the verbal information into a form of a textual file name for a file comprising the recorded digital information; and wherein the first memory is configured to store the file using the textual file name.

In one embodiment of the invention, at least one of the first memory and second memory is an internal memory of at least one of the first electronic device and second electronic device.

In one embodiment of the invention, at least one of the first memory and second memory is a memory medium removably insertable into at least one of the first electronic device and second electronic device.

In one embodiment of the invention, at least one of the first electronic device and second electronic device is one of a mobile terminal, a web camera, digital camera, digital video camera and a computer.

In one embodiment of the invention, the first memory and second memory refer to a single memory area. In another embodiment of the invention, the first memory and second memory refer to separate memory areas.

In one embodiment of the invention, the system further comprises a timer configured to determine a time period during which it is possible to verbally name the digital information.

According to another aspect of the invention there is provided a computer program product of naming a file comprising digital information comprising code stored on a data-processing device readable medium, the code adapted to perform the following steps when executed on a data-processing device: recording digital information with a camera into a file; and naming the file according to verbal information given by a user at close proximity to the recording moment.

In one embodiment of the invention, the computer program product is further adapted to perform the following steps when executed on the data-processing device: storing the recorded digital information; recording verbal information with a microphone; storing the verbal information; converting the recorded verbal information into a form of a textual file name for a file; and saving the file using the textual file name.

In one embodiment of the invention, the computer program product is further adapted to perform the following steps when executed on the data-processing device: storing the recorded digital information; recording verbal information with a microphone in connection with an electronic device; storing the verbal information; and associating the recorded verbal information with the recorded digital information.

In one embodiment of the invention, the computer program product is further adapted to perform the following steps when executed on the data-processing device: converting the recorded verbal information into a form of a textual file name for a file comprising the recorded digital information using the electronic device; and saving the file using the textual file name using the electronic device.

In one embodiment of the invention, the computer program product is further adapted to perform the following step when executed on the data-processing device: transferring the recorded digital information and the recorded verbal information to an external electronic device.

In one embodiment of the invention, the computer program product is stored on a computer readable medium.

In one embodiment of the invention, the step of recording comprises recording the verbal information before recording the digital information. In another embodiment, the step of recording comprises recording the verbal information after recording the digital information.

In one embodiment of the invention, the computer program product is further adapted to perform the following step when executed on the data-processing device: determining a time period during which it is possible to verbally name said digital information.

According to another aspect of the invention there is provided a computer program product of naming a file comprising digital information comprising code stored on a data-processing device readable medium, the code adapted to perform the following steps when executed on a data-processing device: receiving recorded digital information and a recorded verbal information from an electronic device; storing the digital information; storing the verbal information; converting the recorded verbal information into a form of a textual file name for a file comprising the recorded digital information using the external electronic device; and saving the file using the textual file name.

In one embodiment of the invention, the computer program product is stored on a computer readable medium.

According to another aspect of the invention there is provided a computer program product of naming a file comprising digital information comprising code stored on a data-processing device readable medium, the code adapted to perform the following steps when executed on a data-processing device: receiving recorded digital information from an electronic device; storing the digital information; recording verbal information with a microphone; storing the verbal information; converting the recorded verbal information into a form of a textual file name for a file using the external electronic device; and saving the file using the textual file name.

In one embodiment of the invention, the computer program product is stored on a computer readable medium.

In one embodiment of the invention, the step of recording comprises recording the verbal information before recording the digital information. In another embodiment, the step of recording comprises recording the verbal information after recording the digital information.

In one embodiment of the invention, the computer program product is further adapted to perform the following step when executed on the data-processing device: determining a time period during which it is possible to verbally name said digital information.

The present invention has several advantages over the prior-art solutions. The invention provides a user with an enhanced user experience. Furthermore, the solution disclosed in the invention is useful e.g. during holidays when a large number of pictures and videos are taken and naming all of them becomes cumbersome. Furthermore, the invention discloses an easy and illustrative way to name digital picture and video clip files.

A further advantage of the invention is that when files, e.g. image and video files, are named with illustrative names when the image or video files are recorded, then a later searching and arranging of the files becomes easier.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart illustrating one embodiment of the method in accordance with the invention,

FIG. 2 is a block diagram illustrating one embodiment of the system in accordance with the invention;

FIG. 3 is a flow chart illustrating another embodiment of the method in accordance with the invention;

FIG. 4 is a block diagram illustrating another embodiment of the system in accordance with the invention;

FIG. 5 is a flow chart illustrating another embodiment of the method in accordance with the invention;

FIG. 6 is a block diagram illustrating another embodiment of the system in accordance with the invention;

FIG. 7 is a flow chart illustrating another embodiment of the method in accordance with the invention; and

FIG. 8 is a block diagram illustrating another embodiment of the system in accordance with the invention.

### DETAILED DESCRIPTION OF THE PREFERRED EMBODIMENTS

Reference will now be made in detail to the embodiments of the present invention, examples of which are illustrated in the accompanying drawings.

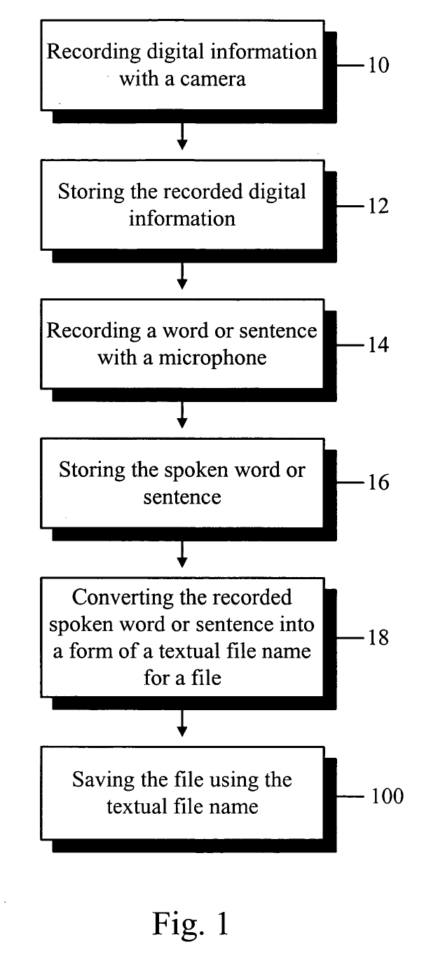

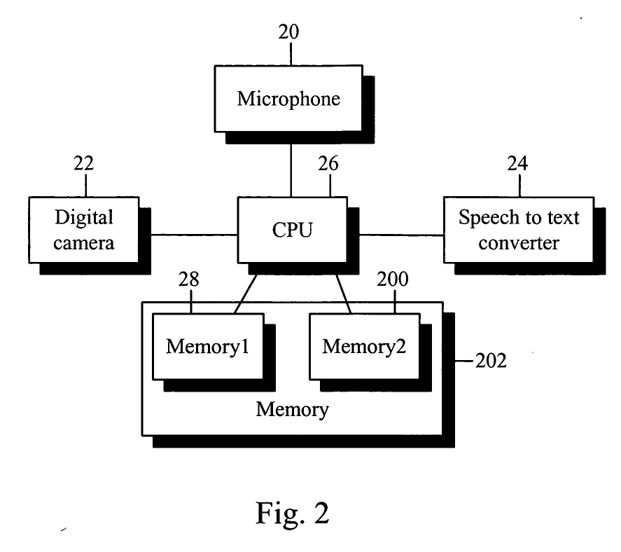

FIG. 1 is a flow chart illustrating one embodiment of the method in accordance with the invention. FIG. 2 illustrates one embodiment of an electronic device in accordance with the invention. For convenience, the description below refers both to FIG. 1 and FIG. 2 at the same time.

At step 10 digital information is recorded using a camera 22. Digital information refers e.g. to a digital picture taken with a digital camera or to a video clip taken with the digital camera. The recorded digital information is stored on a memory 202, and in particular, on a first memory 28, as illustrated at step 12. Camera 22 may be incorporated into an electronic device, e.g. a mobile phone. Camera 22 may also be an external device to the electronic device. T electronic device may be e.g. a mobile terminal, a mobile phone, a digital camera, a digital video camera or a computer.

The electronic device of FIG. 2 further comprises a central processing unit (CPU) 26 operating the electronic device. Memory 202 may refer to a single memory or memory area or to a plurality memories or memory areas that may include e.g. random access memories (RAM), read-only memories (ROM) etc. Memory 202 may also include other applications or software components that are not described in more detail and also may include the computer program, which when executed on the CPU performs the steps of FIG. 1.

In order to name a file comprising digital information as desired, the electronic device comprises or has a connection to a microphone 20 that is used to record verbal information, e.g. a word or sentence spoken by a user of the electronic device into memory 200, and in particular, on a second memory 200, as illustrated at steps 14 and 16. In one embodiment, the verbal information is recorded at the same time or after recording the digital information. In another embodiment, the verbal information is recorded before recording the digital information. Furthermore, in one embodiment the user of the electronic device is able to determine the time period (time before or time after recording the digital information) during which it is possible to verbally name digital information to be recorded or the already recorded digital information. Therefore, the electronic device may comprise a timer configured to determine a time period during which it is possible to verbally name said digital information.

The recorded verbal information is then converted with a speech to text converter 24 into a form of a textual file same, as illustrated at step 18. At step 100, the file comprising the digital information is then saved using the textual file name in memory 200.

In one embodiment of FIG. 1 and 2, the speech to text conversion is performed right after a digital picture or video clip has been taken. In another embodiment, the file is renamed later on using the same procedure as disclosed above. Therefore, an association is established between a spoken word or a sentence and a piece of recorded digital information. Thus, it is possible to make the actual speech to text conversion later on.

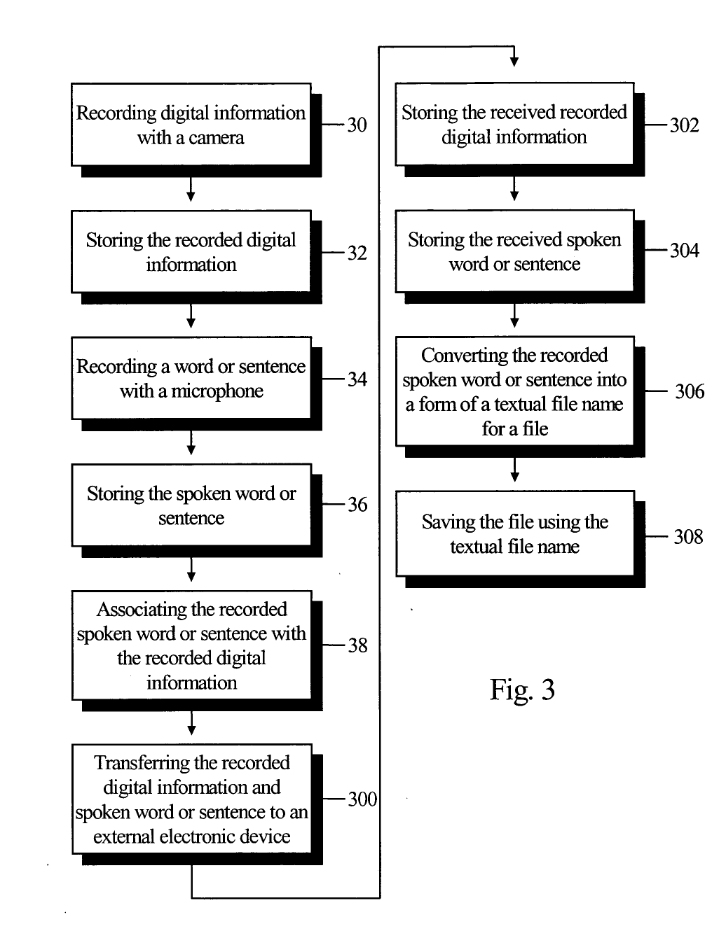

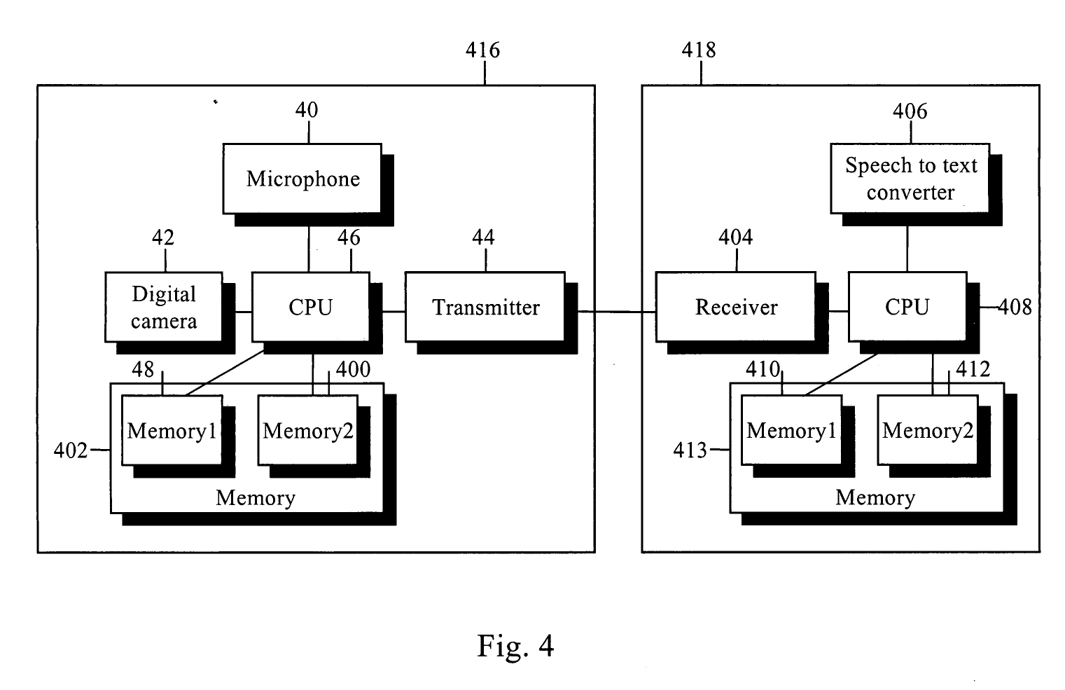

FIG. 3 is a flow chart illustrating another embodiment of the method in accordance with the invention. FIG. 4 illustrates another embodiment of the system in accordance with the invention. For convenience, the description below refers both to FIG. 3 and FIG. 4 at the same time. FIG. 4 includes a first electronic device 416 and a second electronic device 418. The first electronic device 416 is e.g. a mobile terminal, a mobile phone, a digital camera, digital video camera, a web cameras etc. The second electronic device 418 is e.g. a computer.

At step 30 digital information is recorded using a camera 42. Digital information refers e.g. to a digital picture taken with a digital camera or to a video clip taken with the digital camera. The recorded digital information is stored on a memory 402, and in particular, on a first memory 48, as illustrated at step 32. Camera 42 may be incorporated into the first electronic device 416. Camera 42 may also be an external device to the first electronic device 416.

The first electronic device 416 further comprises a central processing unit (CPU) 46 operating the first electronic device 416. Similarly, the second electronic device 418 also comprises a central processing unit 408 operating the second electronic device 418. Memory 402 may refer to a single memory or memory area or to a plurality memories or memory areas that may include e.g. random access memories (RAM), read-only memories (ROM) etc. Memory 402 may also include other applications or software components that are not described in more detail and also may include the computer program (or portion thereof), which when executed on the CPU performs at least some of the steps of FIG. 3.

In order to name a file comprising digital information as desired, microphone 40 that is used to record verbal information, e.g. a word or sentence spoken by a user of the first electronic device 416, as illustrated at step 34. Microphone 40 may also be an external device to the first electronic device 416. In one embodiment, the verbal information is recorded at the same time or after recording the digital information. In another embodiment, the verbal information is recorded before recording the digital information. Furthermore, in one embodiment the user of the first electronic device 416 is able to determine the time period (time before or time after recording the digital information) during which it is possible to verbally name digital information to be recorded or the already recorded digital information. Therefore, the first electronic device 416 may comprise a timer configured to determine a time period during which it is possible to verbally name said digital information. The recorded verbal information is stored on a second memory 400, as illustrated at step 36.

In this embodiment, the actual speech to text conversion is performed in the second electronic device 418, e.g. in a computer. Therefore, an association is established between a spoken word or a sentence and a piece of recorded digital information in memories 48 and 400, as illustrated at step 38. Thus, it is possible to make the actual speech to text conversion later on.

The recorded digital information and verbal information are then transferred to the second electronic device 418 with a transmitter 44, wherein the transmitted information is received with a receiver 404, as illustrated at step 300. Memory 413 may refer to a single memory or memory area or to a plurality memories or memory areas that may include e.g. random access memories (RAM), read-only memories (ROM) etc. Memory 413 may also include other applications or software components that are not described in more detail and also may include the computer program (or portion thereof), which when executed on the CPU performs at least some of the steps of FIG. 3. The received recorded digital information is then stored on a first memory 410, as illustrated at step 302. Similarly, the received recorded verbal information is stored on a second memory 412, as illustrated at step 304. At step 306, the recorded verbal information is then converted with a speech to text converter 408 into a form of a textual file name for a file comprising the recorded digital information. At step 308, the file comprising the digital information is then saved into the first memory 410 using the textual file name.

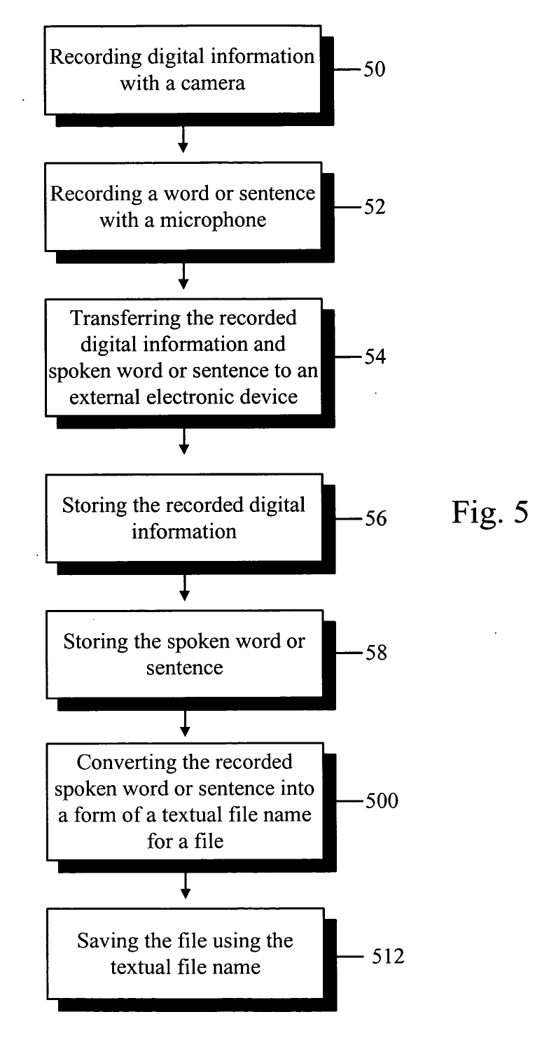

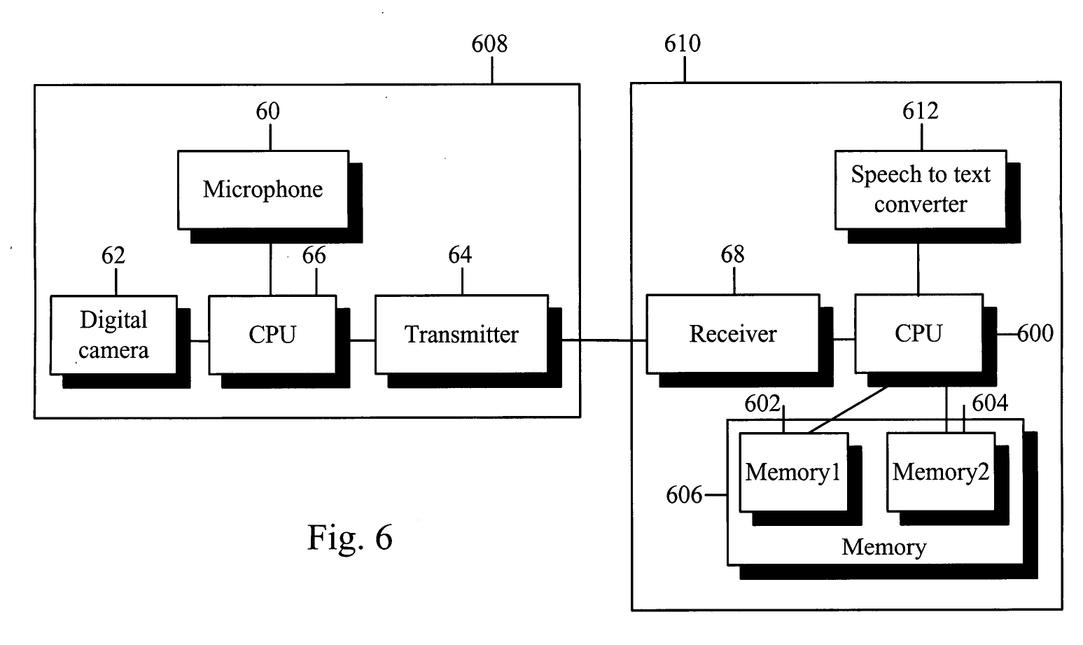

FIG. 5 is a flow chart illustrating another embodiment of the method in accordance with the invention. FIG. 6 illustrates another embodiment of the system in accordance with the invention. For convenience, the description below refers both to FIG. 5 and FIG. 6 at the same time. FIG. 6 includes a first electronic device 608 and a second electronic device 610. The first electronic device 608 is e.g. a mobile terminal, a mobile phone, a digital camera, digital video camera, a web camera etc. The second electronic device 610 is e.g. a computer.

The first electronic device 608 further comprises a central processing unit (CPU) 66 operating the first electronic device 608. Similarly, the second electronic device 610 also comprises a central processing unit 600 operating the second electronic device 610. Furthermore, the electronic first device 608 comprises a microphone 60, a camera 62 and a transmitter 64. Microphone 60 may also be an external device to the first electronic device 608.

In this embodiment, the first electronic device acts only as a recording device that does not store digital information or verbal information at all. Instead it immediately transmits it further on. At step 50 digital information is recorded using camera 62. Digital information refers e.g. to a digital picture taken with a digital camera or to a video clip taken with the digital camera. Camera 62 may be incorporated into the first electronic device 608. Alternatively, camera 62 may also be an external device to the first electronic device 608.

In order to name a file comprising digital information as desired, microphone 60 that is used to record verbal information, e.g. a word or sentence spoken by a user of the first electronic device 608, as illustrated at step 52. In one embodiment, the verbal information is recorded at the same time or after recording the digital information. In another embodiment, the verbal information is recorded before recording the digital information. Furthermore, in one embodiment the user of the second electronic device 610 is able to determine the time period (time before or time after recording the digital information) during which it is possible to verbally name digital information to be recorded or the already recorded digital information using the first electronic device 608. Therefore, the second electronic device 610 may comprise a timer configured to determine a time period during which it is possible to verbally name said digital information.

The recorded digital information and verbal information are immediately transmitted to the second electronic device 610 using a transmitter 64. A receiver 68 is configured to receive the transmitted pieces of information.

In this embodiment, the actual speech to text conversion is performed in the second electronic device 610, e.g. in a computer. The received recorded digital information is then stored on a first memory 602, as illustrated at step 56. Similarly, the received recorded verbal information is stored on a second memory 604, as illustrated at step 58. At step 500, the recorded verbal information is then converted with a speech to text converter 612 into a form of a textual file same for a file comprising the recorded digital information. At step 502, the file comprising the digital information is then saved into the first memory 602 using the textual file name.

FIG. 6 illustrates a single memory 606 including two memories 602 and 604. Memory 606 may refer to a single memory or memory area or to a plurality memories or memory areas that may include e.g. random access memories (RAM), read-only memories (ROM) etc. Memory 606 may also include other applications or software components that are not described in more detail and also may include the computer program (or portion thereof), which when executed on the CPU performs at least some of the steps of FIG. 5. CPU 66 may also include memory or a memory may be associated therewith which may include the computer program (or portion thereof) which when executed on CPU 66 performs at least some of the steps of FIG. 5.

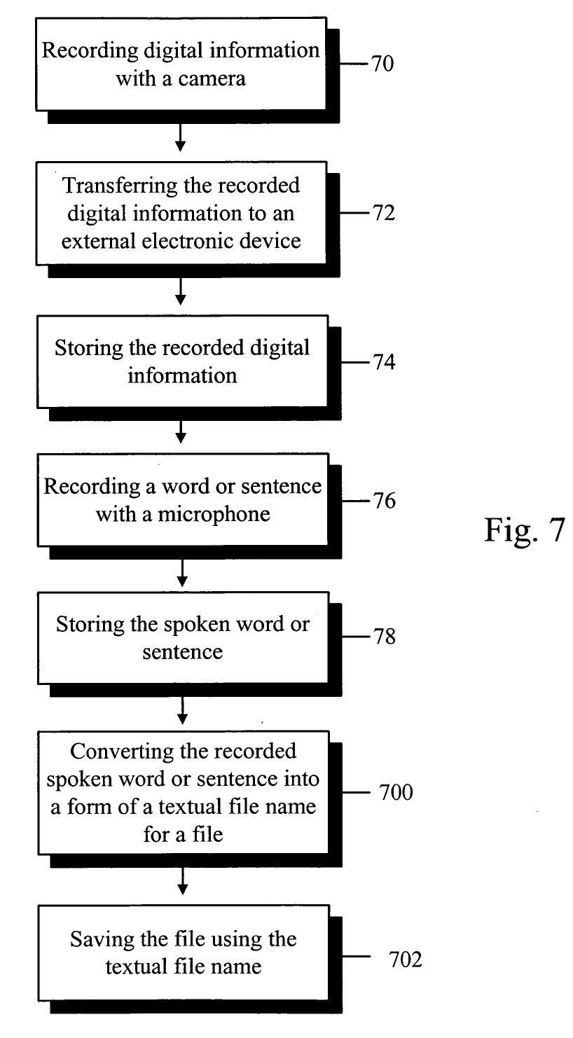

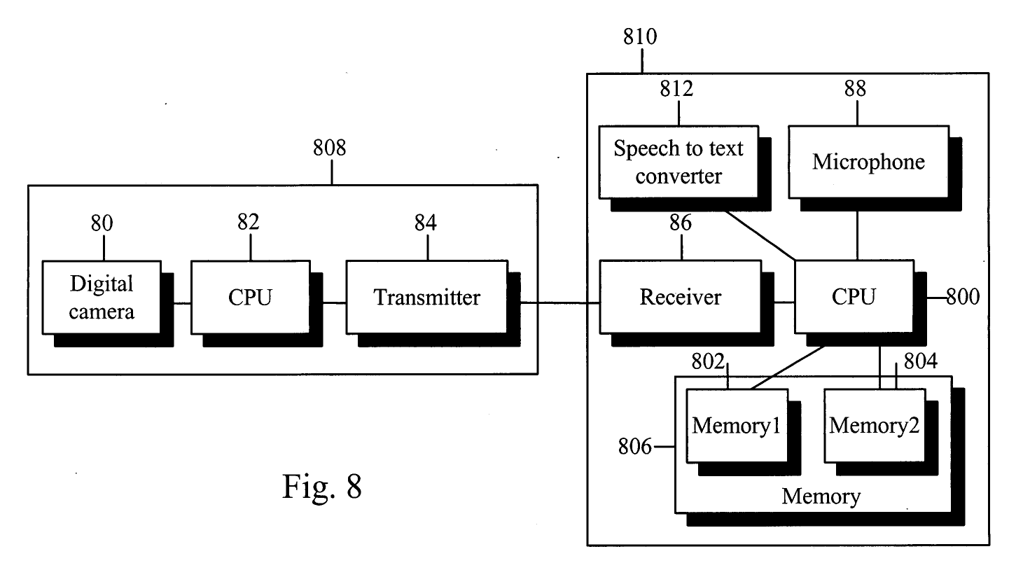

FIG. 7 is a flow chart illustrating another embodiment of the method in accordance with the invention. FIG. 8 illustrates another embodiment of the system in accordance with the invention. For convenience, the description below refers both to FIG. 7 and FIG. 8 at the same time. FIG. 8 includes a first electronic device 808 and a second electronic device 810. The first electronic device 808 is e.g. a mobile terminal, a mobile phone, a digital camera, digital video camera, a web camera etc. The second electronic device 810 is e.g. a computer.

In this embodiment, the first electronic device 808 acts only as a recording device that does not store information at all but immediately transmits it further on to the second electronic device 810. At step 70 digital information is recorded using a camera 80. Digital information refers e.g. to a digital picture taken with a digital camera or to a video clip taken with the digital camera. Camera 80 may be incorporated into the first electronic device 808. Alternatively, camera 80 may also be an external device to the first electronic device 808.

The first electronic device 808 further comprises a central processing unit (CPU) 82 operating the first electronic device 808. Similarly, the second electronic device 810 also comprises a central processing unit 800 operating the second electronic device 810.

In order to name a file comprising digital information as desired, the recorded digital information is immediately transmitted to the second electronic device 810 using a transmitter 84. A receiver 86 is configured to receive the transmitted pieces of information.

In this embodiment, the actual speech to text conversion is performed in the second electronic device 810, e.g. in a computer. The received recorded digital information is stored on a first memory 802, as illustrated at step 74. A user of the second electronic device 810 records with a microphone 88 verbal information, e.g. a word or a sentence that is stored on a second memory 804, as illustrated at steps 76 and 78. In one embodiment, the verbal information is recorded at the same time or after recording the digital information. In another embodiment, the verbal information is recorded before recording the digital information. Furthermore, in one embodiment the user of the second electronic 810 device is able to determine the time period (time before or time after recording the digital information) during which it is possible to verbally name digital information to be recorded or the already recorded digital information. Therefore, the second electronic device 810 may comprise a timer configured to determine a time period during which it is possible to verbally name said digital information.

At step 800, the recorded verbal information is then converted with a speech to text converter 812 into a form of a textual file same for a file comprising the recorded digital information. At step 702, the file comprising the digital information is then saved into the first memory 802 using the textual file name.

FIG. 8 illustrates a single memory 806 including two memories 802 and 804. Memory 806 may refer to a single memory or memory area or to a plurality memories or memory areas that may include e.g. random access memories (RAM), read-only memories (ROM) etc. Memory 806 may also include other applications or software components that are not described in more detail and also may include the computer program (or portion thereof), which when executed on the CPU performs at least some of the steps of FIG. 7. CPU 82 may also include memory or a memory may be associated therewith which may include the computer program (or portion thereof) which when executed on CPU 82 performs at least some of the steps of FIG. 7.

In one embodiment of FIGS. 2, 4, 6 and 8, the electronic device is a mobile terminal, e.g. a mobile phone. Some of the mobile phones in the market include a built-in digital camera. Furthermore, every mobile phone includes also a microphone. Therefore, with a solution in accordance with the invention, it is possible to name a file comprising digital information using the standard microphone of the mobile phone.

In another embodiment of FIGS. 2, 4, 6 and 8, the electronic device is a digital camera. Most of the digital cameras on the market include also a microphone for sound recording. Therefore, when the digital camera is equipped with a speech to text converter and needed software, it is possible to name files (pictures or video clips) to have more user-friendly names, as illustrated in the invention.

It is evident for a person skilled in the art that the electronic devices disclosed in FIG. 2, 4, 6 and 8 may also contain elements, components and software not disclosed above.

Based on the above description it is also evident that the first and second electronic device comprise appropriate computer programs that provide all the aforementioned functionalities.

It is obvious to a person skilled in the art that with the advancement of technology, the basic idea of the invention may be implemented in various ways. The invention and its embodiments are thus not limited to the examples described above, instead they may vary within the scope of the claims.

1. A method of naming a file comprising digital information using an electronic device comprising or connected to a camera, the method comprising:
recording digital information with a camera into a file; and
naming said file according to verbal information given by a user at close proximity to the recording moment.

2. The method according to claim 1, further comprising:
storing said recorded digital information;
recording said verbal information with a microphone;
storing said verbal information;
converting said recorded verbal information into a form of a textual file name for a file comprising said recorded digital information; and
saving said file using said textual file name.

3. The method according to claim 1, further comprising:
storing said recorded digital information;
recording verbal information with a microphone in connection with said electronic device;
storing said verbal information; and
associating said recorded verbal information with said recorded digital information.

4. The method according to claim 3, further comprising:
converting said recorded verbal information into a form of a textual file name for a file comprising said recorded digital information using said electronic device; and
saving said file using said textual file name using said electronic device.

5. The method according to claim 3, further comprising:
transferring said recorded digital information and said recorded verbal information to an external electronic device;
storing said recorded digital information;
storing said recorded verbal information;
converting said recorded verbal information into a form of a textual file name for a file comprising said recorded digital information using said external electronic device; and
saving said file using said textual file name.

6. The method according to claim 1, further comprising:
recording verbal information with a microphone in connection with said electronic device;
transferring said recorded digital information and said verbal information to an external electronic device;
storing said digital information;
storing said verbal information;
converting said verbal information into a form of a textual file name for a file comprising said recorded digital information using said external electronic device; and
saving said file using said textual file name.

7. The method according to claim 1, further comprising:
transferring said recorded digital information to an external electronic device;
storing said digital information;
recording verbal information with a microphone in connection with said external electronic device;
storing said verbal information;
converting said recorded verbal information into a form of a textual file name for a file comprising said recorded digital information using said external electronic device; and
saving said file using said textual file name.

8. The method according to claim 2, wherein said step of recording comprising recording said verbal information before recording said digital information.

9. The method according to claim 2, wherein said step of recording comprising recording said verbal information after recording said digital information.

10. The method according to claim 2, further comprising the step of:
determining a time period during which it is possible to verbally name said digital information.

11. The method according to claim 1, wherein said electronic device is one of a mobile terminal, a web camera, digital camera, digital video camera and a computer.

12. An electronic device comprising:
a camera or a connection to a camera configured to record digital information;
a first memory configured to store said digital information;
a microphone configured to record verbal information;
a second memory configured to store said verbal information;
a converter configured to convert said verbal information into a form of a textual file name for a file comprising said recorded digital information; and
wherein said first memory is configured to store said file using said textual file name.

13. An electronic device comprising:
a camera or a connection to a camera configured to record digital information;
a first memory configured to store said digital information;
a microphone configured to record verbal information;
a second memory configured to store said verbal information, wherein said first memory and second memory are associated so that said recorded verbal information is linked with said recorded digital information; and
a transmitter configured to transmit said recorded digital information and said associated recorded verbal information to an external electronic device.

14. The electronic device according to claim 12, wherein said electronic device is one of a mobile terminal, a web camera, digital camera, digital video camera and a computer.

15. The electronic device according to claim 12, wherein at least one of said first memory and second memory is an internal memory of said electronic device.

16. The electronic device according to claim 12, wherein at least one of said first memory and second memory is a memory medium removably insertable into said electronic device.

17. The electronic device according to claim 12, wherein said first memory and second memory refer to a single memory area.

18. The electronic device according to claim 12, wherein said first memory and second memory refer to separate memory areas.

19. The electronic device according to claim 12, further comprising a timer configured to determine a time period during which it is possible to verbally name said digital information.

20. An external electronic device comprising:
a receiver configured to receive recorded digital information and associated recorded verbal information from an electronic device;
a first memory configured to store said digital information;
a second memory configured to store said verbal information;
a converter configured to convert said verbal information into a form of a textual file name for a file comprising said recorded digital information; and
wherein said first memory is configured to store said file comprising said recorded digital information using said textual file name.

21. An external electronic device comprising:
a receiver configured to receive recorded digital information a from an electronic device;
a first memory configured to store said digital information;
a microphone configured to record verbal information;
a second memory configured to store said verbal information;
a converter configured to convert said verbal information into a form of a textual file for a file comprising said recorded digital information; and
wherein said first memory is configured to store said file comprising said recorded digital information using said textual file name.

22. The external electronic device according to claim 20, wherein said electronic device is one of a mobile terminal and a computer.

23. The external electronic device according to claim 20, wherein at least one of said first memory and second memory is an internal memory of said external electronic device.

24. The external electronic device according to claim 20, wherein at least one of said first memory and second memory is a memory medium removably insertable into said external electronic device.

25. The external electronic device according to claim 20, wherein said first memory and second memory refer to a single memory area.

26. The external electronic device according to claim 20, wherein said first memory and second memory refer to separate memory areas.

27. The external electronic device according to claim 21, further comprising a timer configured to determine a time period during which it is possible to verbally name said digital information.

28. A system of naming a file comprising digital information, the system comprising:
an electronic device comprising a camera or connected to a camera configured to record digital information; a first memory configured to store said recorded digital information; a microphone configured to record verbal information; a second memory configured to store said verbal information; a converter configured to convert said verbal information into a form of a textual file name for a file comprising said recorded digital information; wherein said first memory is configured to store said file comprising said recorded digital information using said textual file name.

29. A system of naming a file comprising digital information, the system comprising:
a first electronic device; wherein said first electronic device comprises a camera or is connected to a camera configured to record digital information; a first memory configured to store said recorded digital information; a microphone in connection with said first electronic device configured to record verbal information; a second memory configured to store said verbal information, wherein said first memory and second memory are associated so that said recorded verbal information is linked with said recorded digital information; and a transmitter configured to transmit said recorded digital information and said associated recorded verbal information to a second electronic device external to said first electronic device; and
a second electronic device, wherein said second electronic device comprises a receiver configured to receive said recorded digital information and associated recorded verbal information from said first electronic device; a first memory configured to store said recorded digital information; a second memory configured to store said verbal information; a converter configured to convert said verbal information into a form of a textual file name for a file comprising said recorded digital information; and wherein said first memory is configured to store said file using said textual file name.

30. A system of naming a file comprising digital information, the system comprising:
a first electronic device, wherein said first electronic device comprises a camera or is connected to a camera configured to record digital information; a microphone in connection with said first electronic device configured to record verbal information; and a transmitter configured to transmit said recorded digital information and said recorded verbal information to a second electronic device external to said first electronic device; and
a second electronic device, wherein said second electronic device comprises a receiver configured to receive said recorded digital information and said recorded verbal information from said first electronic device; a first memory configured to store said recorded digital information; a second memory configured to store said verbal information; a converter configured to convert said verbal information into a form of a textual file name for a file comprising said recorded digital information; and wherein said first memory is configured to store said file using said textual file name.

31. A system of naming a file comprising digital information, the system comprising:
a first electronic device, wherein said first electronic device comprises a camera or is connected to a camera configured to record digital information; and a transmitter configured to transmit said recorded digital information to a second electronic device external to said first electronic device; and
a second electronic device, wherein said second electronic device comprises a receiver configured to receive said recorded digital information from said first electronic device; a first memory configured to store said recorded digital information; a microphone in connection with said second electronic device configured to record verbal information; a second memory configured to store said verbal information; a converter configured to convert said verbal information into a form of a textual file name for a file comprising said recorded digital information; and wherein said first memory is configured to store said file using said textual file name.

32. The system according to claim 28, wherein at least one of said memories is an internal memory of at least one of said first electronic device and second electronic device.

33. The system according to claim 28, wherein at least one of said first memory and second memory is a memory medium removably insertable into at least one of said first electronic device and second electronic device.

34. The system according to claim 28, wherein at least one of said first electronic device and second electronic device is one of a mobile terminal, a web camera, digital camera, digital video camera and a computer.

35. The system according to claim 28, wherein said first memory and second memory refer to a single memory area.

36. The system according to claim 28, wherein said first memory and second memory refer to separate memory areas.

37. The system according to claim 28, further comprising a timer configured to determine a time period during which it is possible to verbally name said digital information.

38. A computer program product of naming a file comprising digital information comprising code stored on at least one data-processing device readable medium, the code adapted to perform the following steps when executed on a data-processing device:
recording digital information with a camera into a file; and
naming said file according to verbal information given by a user at close proximity to the recording moment.

39. The computer program product according to claim 38, further adapted to perform the following steps when executed on said data-processing device:
storing said recorded digital information;
recording said verbal information with a microphone;
storing said verbal information;
converting said recorded verbal information into a form of a textual file name for a file; and
saving said file using said textual file name.

40. The computer program product according to claim 38, further adapted to perform the following steps when executed on said data-processing device:
storing said recorded digital information;
recording verbal information with a microphone in connection with said electronic device;
storing said verbal information; and
associating said recorded verbal information with said recorded digital information.

41. The computer program product according to claim 40, further adapted to perform the following steps when executed on said data-processing device:
converting said recorded verbal information into a form of a textual file name for a file comprising said recorded digital information using said electronic device; and
saving said file using said textual file name using said electronic device.

42. The computer program product according to claim 40, further adapted to perform the following step when executed on said data-processing device:
transferring said recorded digital information and said recorded verbal information to an external electronic device.

43. The computer program product according to claim 38, wherein said computer program product is stored on a computer readable medium.

44. The computer program product according to claim 39, wherein said step of recording comprising recording said verbal information before recording said digital information.

45. The computer program product according to claim 39, wherein said step of recording comprising recording said verbal information after recording said digital information.

46. The computer program product according to claim 39, further adapted to perform the following step when executed on said data-processing device:
determining a time period during which it is possible to verbally name said digital information.

47. A computer program product of naming a file comprising digital information comprising code stored on at least one data-processing device readable medium, the code adapted to perform the following steps when executed on a data-processing device:
receiving recorded digital information and a recorded verbal information from an electronic device;
storing said digital information;
storing said verbal information;
converting said recorded verbal information into a form of a textual file name for a file comprising said recorded digital information using said external electronic device; and
saving said file using said textual file name.

48. The computer program product according to claim 47, wherein said computer program product is stored on a computer readable medium.

49. A computer program product of naming a file comprising digital information comprising code stored on at least one data-processing device readable medium, the code adapted to perform the following steps when executed on a data-processing device:
receiving a recorded digital information from an electronic device;
storing said digital information;
recording verbal information with a microphone;
storing said verbal information;
converting said recorded verbal information into a form of a textual file name for a file using said external electronic device; and
saving said file using said textual file name.

50. The computer program product according to claim 49, wherein said computer program product is stored on a computer readable medium.

51. The computer program product according to claim 49, wherein said step of recording comprises recording said verbal information before recording said digital information.

52. The computer program product according to claim 49, wherein said step of recording comprises recording said verbal information after recording said digital information.

53. The computer program product according to claim 49, further adapted to perform the following step when executed on said data-processing device:
determining a time period during which it is possible to verbally name said digital information.
